(19) United States
(12) Patent Application Publication
(10) Pub. No.: US 2010/0132407 A1
(43) Pub. Date: Jun. 3, 2010

(54) METHOD FOR PRODUCING A TUBE OF QUARTZ GLASS BY ELONGATING A HOLLOW CYLINDER OF QUARTZ GLASS

(75) Inventors: Oliver Ganz, Bruchkoebel (DE); Thomas Bogdahn, Karlstein (DE); Harald Hain, Kahl (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmbH & Co. KG, Hanau (DE)

(21) Appl. No.: 12/451,360

(22) PCT Filed: Apr. 29, 2008
(86) PCT No.: PCT/EP2008/055217

§ 371 Date: Nov. 9, 2009

(30) Foreign Application Priority Data
May 9, 2007 (DE) 102007022272.8

(51) Int. Cl. C03B 23/00

(52) U.S. Cl. 65/108

(57) ABSTRACT

In a known method for producing a tube of quartz glass by elongation, a hollow cylinder of quartz glass is continuously supplied to a heating zone, softened therein zone by zone, and a tube strand is drawn in the direction of a drawing axis out of the softened region by using a roll puller, the roll puller comprising a frame by which a plurality of puller rolls are fixed, which are rotatable around a rotation axis and which are distributed over the circumference of the tube strand and adjoining the tube strand with their cylindrical outer surface. Starting therefrom, to indicate a vertical drawing method in which a high draw ratio can also be accomplished with little constructional effort by using a take-off unit in the form of a roll puller and which simultaneously allows an optimization of the dimensional stability of the quartz glass tubes obtained, and which particularly avoids material losses caused by ovality and siding, the invention suggests that the frame of the roll puller s stationary, and the hollow cylinder and the tube strand are rotated about the drawing axis relative to one another, the relative rotation being set to a range between 0.01 and 5 revolutions per linear meter of drawn-off tube strand.

The present invention relates to a method for producing a tube of quartz glass by elongating a hollow cylinder of quartz glass which is continuously supplied to a heating zone, softened therein zone by zone, and a tube strand is drawn in the direction of a drawing axis out of the softened region by using a roll puller, the roll puller comprising a frame by which a plurality of puller rolls are fixed, which are rotatable around a rotation axis and which are distributed over the circumference of the tube strand and adjoining the tube strand with their cylindrical outer surface.

### BACKGROUND OF THE INVENTION

Vertical drawing methods serve to form hollow cylinders of quartz glass without any tools into tubes of any desired cross-sectional profile. The tubes obtained in this way are for instance used as reactors in the chemical industry or in semiconductor manufacture, as lamp tubes in optics or as start material for producing preforms for optical fibers.

A hollow cylinder is here normally supplied in vertical orientation from above to a heating tube, it is softened therein zone by zone and a tube strand is drawn from the softened region, with a drawing bulb being formed in the softened region.

On the one hand the absence of tools in this forming process yields a low-damage surface of the withdrawn strand. On the other hand, however, the problem arises that the dimensional stability of the withdrawn strand must be ensured without any mechanical intervention. This is particularly rendered difficult by already existing dimensional variations of the hollow cylinder, which tend to continue in the withdrawn tube strand or are even enhanced there. The most frequently found flaws are high-frequency diameter variations and ovalities in the radial cross-sectional profile or wall one-sidedness, i.e. radial irregularities in the thickness of the tube wall, also called “siding” among the experts.

It has been assumed that ovality and siding are due to a radially inhomogeneous temperature profile in the area of the drawing bulb and that this effect can be compensated by rotating the hollow cylinder about its longitudinal axis. A corresponding method and a corresponding apparatus for performing the method are known from DE 199 49 411 A1. A cylindrical semifinished product is here elongated into a strand, the semifinished product and the strand rotating in synchronism about their joint longitudinal axis extending in parallel with the drawing axis. To improve the guidance of the drawn-off strand, guide bodies are used that are arranged opposite each other in pairs and configured as rolls. The draw-off device itself is not described in DE 199 49 411 A1.

A synchronous rotation of semifinished product and drawn-off strand during drawing of a fiber preform from a coaxial assembly consisting of jacket tube and core rod is also suggested in EP 994 078 B1. To diminish the ovality of the fiber preform the rotational speed is set to at least 5 rpm. This document does also not describe the take-off device itself.

For reducing variations in the diameter during elongation of a preform, U.S. Pat. No. 6,178,778 B1 also recommends a synchronous rotation of semifinished product and drawn-off strand. The take-off unit consists of one or preferably several grippers arranged relative to one another, which are moved along a vertical guide upwards and downwards in such fashion that at least one gripper is always acting on the drawn-off strand.

Methods and devices in which the glass strand is gripped at its front end by means of a gripper element and drawn off have the drawback that the glass strand length that can be drawn at the most is limited by the dimension of the take-off device. Large take-off lengths require long or high structures. Likewise, the alternative procedure which employs a plurality of reversingly movable grippers is relatively complicated from a constructional point of view.

WO 03/022757 A1 discloses a vertical drawing process in which a glass strand is drawn off by means of a so-called “roll puller” (roll hauler). The roll puller comprises a plurality of puller rolls which are fixed within a frame and which are distributed over the glass strand to be drawn off, which rolls are opposite each other on the glass strand to be drawn off and exert a force on said strand that is suited to draw off the glass strand. To this end the roll puller is provided with a torque control by means of which the torque of the puller rolls is continuously adapted to that of a reference roll and is readjusted.

The take-off unit in the form of a roll puller permits continuous drawing of the glass strand with comparatively small constructional efforts. This advantage, however, is forfeited when the roll puller is configured to be rotatable about the drawing axis so as to permit rotation of the drawn-off glass strand.

A method and a device of this kind are described in GB 1 315 447 A. For drawing a tubular or rod-shaped strand of quartz glass from a starting cylinder in a horizontal drawing method, this publication suggests a device which comprises a first working head by means of which the start cylinder is held and supplied to a heating zone, and a second working head by means of which the strand is drawn off. Both working heads are rotatable by means of a rotation device about the drawing axis. The working head which serves withdrawal purposes comprises two rolls that are pressed by means of spring biased levers against the strand to be drawn off, thereby effecting withdrawal and rotation of the strand to be drawn off about the drawing axis. This device is very complicated in its construction.

### SUMMARY OF THE INVENTION

It is the object of the present invention to provide a vertical drawing method in which a high draw ratio can also be achieved with little constructional effort by using a take-off unit in the form of a roll puller, and which simultaneously allows an optimization of the dimensional stability of the quartz glass tubes obtained, and which particularly avoids material losses caused by ovality and siding.

Starting from the above-mentioned method this object is achieved according to the invention in that the frame of the roll puller is stationary, and the hollow cylinder and the tube strand are rotated about the drawing axis relative to one another, the relative rotation being set to a range between 0.01 and 5 revolutions per linear meter of drawn-off tube strand.

The longitudinal axes of the drawn-off tube strand and of the hollow cylinder of quartz glass are rotated in the elongation process relative to one another, which in the softened area of the drawing bulb results in a plastic deformation and mixing of the quartz glass, which shall also be called “twisting” in the following. Twisting is accomplished in that hollow cylinder and tube strand are rotated about the drawing axis in opposite directions or at different speeds, wherein one of the two rotational speeds may also be zero.

It is fundamentally known that the twisting operation makes the temperature distribution homogeneous, so that asymmetries in the area of the heating zone are compensated. Geometric tube defects, such as ovality and siding, can be reduced thereby and possible radial inhomogeneities in the material are eliminated completely or in part. For instance, it is suggested in JP 2006021979 A for making a glass tube that a horizontally oriented hollow cylinder of glass should be softened zone by zone and elongated in this process, the two ends of the hollow cylinder being clamped in the take-up spindles of a lathe-like device. During elongation a twisting operation is carried out in the area of the drawing bulb by the measure that the take-up spindle which grips and draws off the withdrawn tube end is rotating at a higher speed than the opposite spindle.

US 2003/01406598 A1 describes the elongation of a preform into an optical component in the form of a so-called core rod, and the withdrawn core rod and the preform are here also rotated during the drawing process in opposite directions. The drawing device comprises a gripper which acts on the cylindrical outer surface of the withdrawn strand and which is transported in the direction of the drawing axis by means of a spindle downwards. At the same time with the withdrawal movement in drawing direction, a rotational movement about the drawing axis is thus applied to the withdrawn core rod, said movement being continued on the drawing bulb, so that the soft quartz glass mass is twisted there. Values in the range between 5 to 70 cm/min are indicated for the drawing speed, and the rotation rate of the core rod is set such that between 20 and 100 revolutions per linear meter are obtained.

The measures suggested therein are suited for lathe-like drawing devices in the case of which the take-off unit is configured as a lathe chuck or gripper. For a take-off device in the form of a roll puller these methods, however, require rotatability for the drawn-off glass strand, which is difficult to realize constructionally. Moreover, it has been found that the known measures are not adequate for the manufacture of dimensionally accurate quartz glass tubes.

The invention is distinguished by the use of a roll puller for drawing off the tube strand in combination with a comparatively low rate of the relative rotation of drawn-off tube strand and hollow cylinder and at the same time by minor mechanical twisting.

It has been found that a particularly low relative rate of rotation effects an optimum result with respect to a minimization of dimensional deviations in the tube strand that are due to geometric flaws already existing in the hollow cylinder.

Particular attention must here be paid to a wall one-sidedness (siding) already existing in the hollow cylinder. A siding of the hollow cylinder is immediately noticed in a siding of the drawn-off tube strand and cannot be reduced by a synchronous rotation of hollow cylinder and tube strand alone. On the contrary, a siding of the hollow cylinder can effect a radially inhomogeneous temperature distribution which in the drawn-off tube strand may amplify the siding and additionally generate ovality. These effects can be counteracted by slow twisting, which is distinguished by a small relative rotation in a range between 0.01 to 5 revolutions per linear meter of drawn-off tube strand.

According to the invention use is made of a stationary roll puller as the take-off device, i.e., one not rotating about the drawing axis. The roll puller enables any (desired) high draw-off ratio and, together with the small rate of rotation, a constructionally simple implementation of the drawing process, as shall be explained in more detail in the following.

It has been found that high rates of rotation between hollow cylinder and tube strand easily lead to unexpected deformations and disorders in the drawing process, particularly bends. In view of this a procedure has turned out to be particularly useful in which the relative rotation is set to a range of less than one revolution per linear meter of drawn-off tube strand. Particularly preferably, the relative rotation is within the range between 0.05 to 0.5 revolutions per linear meter of drawn-off tube strand.

To avoid the technically complicated construction for realizing a roll puller that is rotatable about the drawing axis, it is intended in a first preferred variant of the method that the hollow cylinder rotates about the drawing axis, and the puller rolls are simultaneously pressed with a press force against the tube strand, said force preventing rotation of the tube strand.

A rotation of the tube strand about the drawing axis is here dispensed with, which simplifies the drawing-off operation using a roll puller. To ensure the twisting in the drawing bulb, the puller rolls must however be pressed against the tube strand so firmly that they counteract rotation.

In an alternative, but equally preferred procedure, however, the tube strand rotates about the drawing axis.

In this case a rotation of the hollow cylinder about the drawing axis can be dispensed with. The rotation of the drawn-off tube strand using the roll puller is here preferably accomplished in that the puller rolls rotate about a rotation axis of the puller rolls, and that the rotation of the tube strand is accomplished in that at least one of the puller rolls is oriented relative to the drawing axis in such an oblique orientation that the rotational axis of the puller rolls encloses a tilt angle (α) different from 90 degrees with the drawing axis.

Usually the axis of rotation of the puller rolls extends in a direction perpendicular to the drawing axis. Possible flat sides (front sides) of the puller roll will then extend in parallel with the vertical drawing axis. This is different in the preferred embodiment where the front sides extend slightly inclined relative to the drawing axis. This orientation produces a force component acting tangentially on the cylinder jacket of the tube strand, which component forces said strand to perform a continuous rotational movement about the drawing axis without the roll puller having to be rotated about the drawing axis to this end. The rotational movement achieved in this way is comparatively small and is in the above-mentioned range between 0.01 to 5 revolutions per linear meter of drawn-off tube strand.

A suitable tilt angle between the rotational axis of the puller rolls and the drawing axis depends in practice on the predetermined rate of the rotation and on the diameter of the tube strand. It has been found that already very small tilt angles (i.e. deviations of 90 degrees) are adequate for a slight relative rotation according to the invention. Preferably, the tilt angle differs by not more than 10 degrees from 90 degrees.

With respect to a contact pressure that is as small as possible between the puller roll and the tube strand and with respect to a distribution of the tangentially acting forces that is as uniform as possible around the circumference of the tube strand, all of the puller rolls of the roll puller are obliquely oriented relative to the drawing axis.

In a particularly preferred embodiment of the method according to the invention, namely during the drawing process on the withdrawn tube strand, a measure is determined for the ovality or siding thereof, and the determined measure is used for controlling the rate of the relative rotation.

The measure regarding ovality or siding of the tube strand can for instance be determined in that measurement values are determined for the outer diameter and the inner diameter (and thus also on the wall thickness) through the circumference of the tube strand. Ovality is determined as the difference between maximal and minimal outer diameter in a given radial tube cross-section and siding as the difference between maximal and minimal wall thickness in a given radial cross-section of the tube. The regulation may aim at a minimization of ovality or a minimization of siding of the tube strand or also be configured with the aim of a minimum value for both dimensional deviations.

Furthermore, it has turned out to be advantageous when a hollow cylinder of quartz glass is used having radial final dimensions produced by mechanical treatment or machining.

With a mechanical treatment (particularly by drilling, honing and grinding) using known honing and grinding methods and commercially available devices suited therefor, it is possible to produce a hollow cylinder of quartz glass having an outer diameter of more than 100 mm and a length of 2 m or more, which is distinguished by an exact cylinder symmetry with an accurate circular cross-section and a small dimensional deviation in the range of 1/100 mm. Bend and ovality of the hollow cylinder can thus be neglected and a siding of the hollow cylinder that might still be found can be minimized by means of the method according to the invention. A mechanically treated hollow cylinder is also a hollow cylinder which has been subjected to a final etching treatment, on account of which the geometry and final dimensions of the hollow cylinder do not significantly change.

The method according to the invention has turned out to be particularly useful in the manufacture of relatively thin-walled tubes, where a tube strand is drawn off with a wall thickness in the range of from 0.1 to 3 mm

The small relative rotation in the method according to the invention predominantly avoids deformations which can destabilize especially thin tube walls and thus lead to a deterioration of the dimensional stability.

### PREFERRED EMBODIMENTS OF THE INVENTION

The invention shall now be explained in more detail with reference to embodiments and a drawing. The drawing is a schematic view and shows in detail in

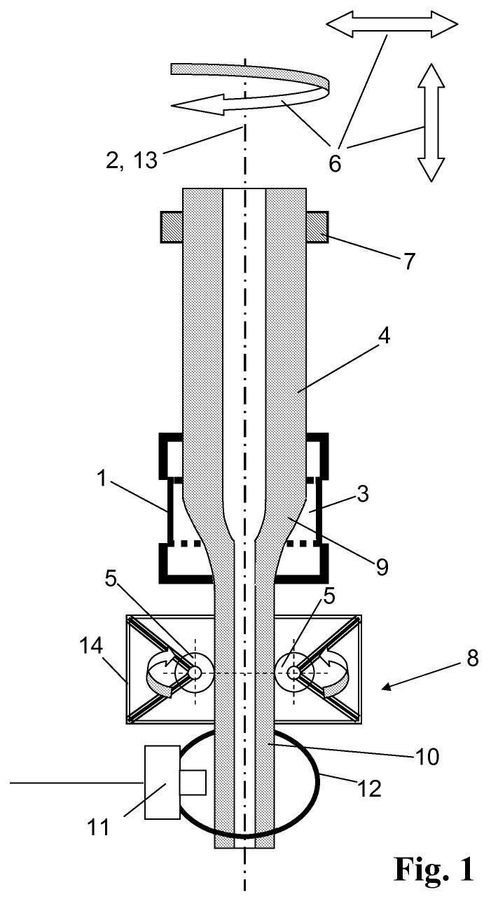

FIG. 1 an apparatus for drawing a tube strand according to the method of the invention;

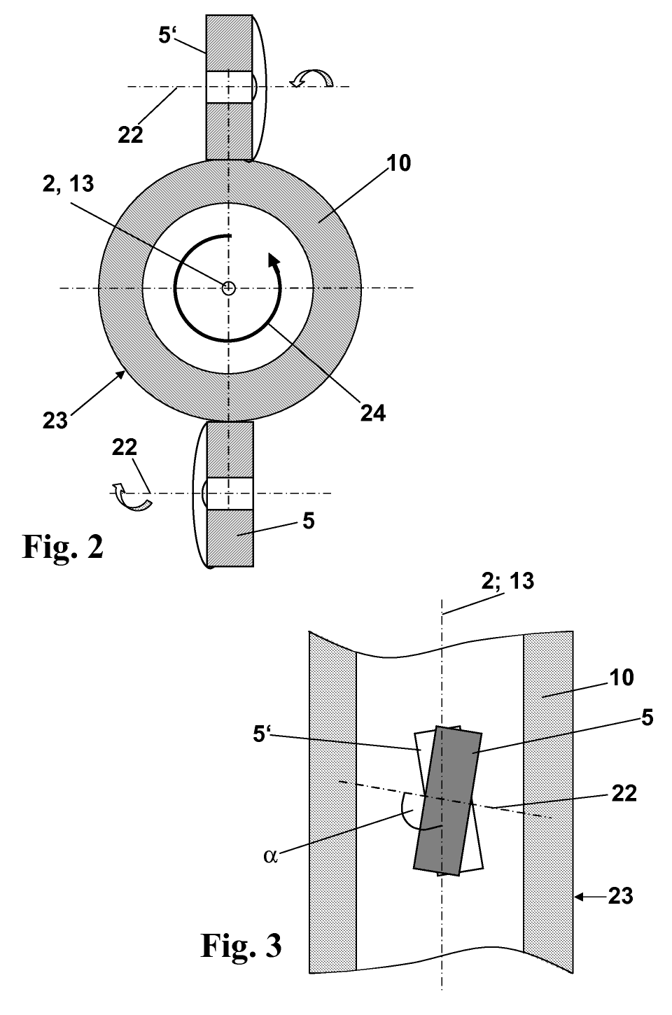

FIG. 2 a detail of an embodiment of the take-off for the tube strand in a top view; and

FIG. 3 a section of the take-off according to FIG. 2 in a side view.

### EXAMPLE 1

The apparatus according to FIG. 1 shows a resistance type heating furnace comprising a vertically oriented heating tube 1 enclosing a heating zone 3 of circular cross-section.

The heating tube 1 consists of an annular graphite element having an inner diameter of 193 mm, an outer diameter of 215 mm and it encloses a heating zone 3 (area of maximum temperature) having a length of 100 mm.

A hollow cylinder 4 of quartz glass projects through the heating tube 1 with a longitudinal axis 13 oriented as much as possible in parallel with the drawing axis 2. The upper end of the hollow cylinder 4 is connected to a gripper 7 by means of which it is displaceable in horizontal direction (xy), movable upwards and downwards in vertical direction and rotatable about the drawing axis 2, as outlined by the directional arrows 6.

The hollow cylinder 4 is softened in the heating zone 3 and a tube 10 is drawn vertically downwards from the softened area with formation of a drawing bulb 9. A roll puller, which is given reference numeral 8 on the whole, serves as a take-off device and comprises two take-off rolls 5 opposing each other at the same height level on the cylinder jacket of the tube. The two take-off rolls 5 are rotatable around a rotation axis and they are fixed within a frame 14 of the roll puller 8.

The tube 10 is passed underneath the roll puller 8 through a sliding contact ring 12 which simultaneously serves as a guide rail for a wall-thickness measuring device 11 which is rotatable about the outer circumference of the tube 10. With the help of the wall-thickness measuring device 11, which is connected to a computer, a wall thickness profile of the drawn-off tube 10 can be recorded during the drawing process, and said profile is evaluated with the help of the computer.

An embodiment for performing the vertical drawing process of the invention for producing a quartz glass tube shall now be explained in more detail in the following with reference to FIG. 1.

In the vertically oriented heating tube 1, a hollow cylinder 4 of quartz glass with an outer diameter of 145 mm and an inner diameter of 60 mm is adjusted such that its longitudinal axis 13 extends in the middle axis of the heating tube 1, which is the drawing axis 2 at the same time. The hollow cylinder 4 of quartz glass is then lowered by means of the gripper 7 at a constant feed rate into the heating tube 1, resulting in a mass flow rate of 9.2 kg/h. In the heating zone, the hollow cylinder 4 is heated to a temperature above 2100° C., the quartz glass tube 10 being drawn from the developing drawing bulb 9 at a controlled drawing speed of about 2.7 m/min to a desired outer diameter of 6 mm and a desired wall thickness of 2 mm while a small negative pressure is maintained in the inner bore of the tube strand 10.

The hollow cylinder 4 is simultaneously rotated with the help of the gripper 7 about its longitudinal axis 13 at a speed of 0.25 rpm, whereas the roll puller 8 does not rotate about this axis 13. The frame 14 of the roll puller 8 is stationary (no rotation around the drawing axis 2), and the take-off rolls 5 are pressed with a press force against the tube strand 10, thereby preventing a co-rotation of the tube strand 10, so that the soft quartz glass mass is twisted in the area of the drawing bulb. This results in 0.093 revolutions per drawn-off linear meter of the tube strand 10. The press force is in the range of from 10 to about 65 kp and is increased with an increasing weight of the tube strand 10, as explained in WO 03/022757 A1.

With the help of the wall-thickness measuring device 11 rotating about the tube strand 10, a wall thickness profile of the drawn-off tube strand 10 is continuously generated and evaluated in the computer with respect to inner diameter, outer diameter, siding (maximum value minus minimum value of the wall thickness) and location of the minimal wall thickness. The measurement values obtained in this way are used for controlling the rotational speed of the hollow cylinder 4 for the purpose of minimizing ovality.

The drawn-off tube strand 10 was cut into tubes having a length of 1.50 m, and the maximum tube ovality was determined. To this end, radial cross-sections of the tube were made at distances of 10 cm and the diameter extension was measured on the basis thereof. Ovality was determined for every cross-section as the difference of maximum outer diameter and minimum outer diameter. The ovality value indicated in Table 1 is the maximum value of all measurement values obtained in this way.

### Example 2

In a variant of the above-explained method, and instead of the hollow cylinder 4 (the gripper 7 does not rotate about the drawing axis 2), the drawn-off tube strand 10 is rotated about its longitudinal axis 13 (and about the drawing axis 2, respectively), without any rotation of the frame 14 of the roll puller 8 around the drawing axis 2 (the frame 14 is stationary). For this purpose the take-off rolls 5, 5′ rotating about their rotational axis 22 are directed obliquely against the cylinder jacket 23 of the tube strand 10, as is schematically shown in FIGS. 2 and 3. The orientation of the take-off rolls 5 is here such that their axis of rotation 22 is not perpendicular to the drawing axis 2, but inclined relative thereto, as can be seen in FIG. 3, where the take-off roll, which is per se concealed by the tube strand 10, is provided with reference numeral 5′. The inclination of the rotation axes 22 of the take-off rolls 5 and 5′ relative to the drawing axis 2 is shown on an exaggerated scale for reasons of better perceptibility. Moreover, FIGS. 1 to 3 are purely schematic illustrations without being true to scale.

In the embodiment the tilt angle α between the drawing axis 2 and the axis of rotation is 90.1 degrees (i.e. a tilt of +/−0.1 degrees in comparison with the otherwise standard perpendicular arrangement of drawing axis 2 and rotation axis 22 without rotation of the tube strand 10).

This orientation of the take-off rolls 5 exerts a force that is tangentially acting on the outer jacket 23 of the tube strand 10, which leads to a continuous rotational movement of the tube strand 10 about the drawing axis 2, as outlined by directional arrow 24. The rotational speed generated in this way is 0.1 revolutions per drawn-off linear meter.

Further drawing tests were performed, as described above in detail with reference to Examples 1 and 2. It was only the rotation rate of hollow cylinder (by analogy with Example 1) or that of the tube strand (by analogy with Example 2) that was here varied. All of the measurement samples were evaluated with respect to maximum ovality and their bend. For determining the bend the surface of the tube is scanned in the direction of its central axis and the maximum distance to the central axis is here determined. The bend value indicated in Table 1 follows as a maximal distance (in mm) based on the tube length (in m). The corresponding tests and the results obtained with respect to tube siding are summarized in Table 1. The Comparative Example 2 represents a standard measurement sample that has been produced without any twisting.

TABLE 1

| Process + | | | | | | | Comp. | Comp. |
|---|---|---|---|---|---|---|---|---|
| property | Example 1 | Example 2 | Example 3 | Example 4 | Example 5 | Example 6 | Example 1 | Example 2 |
| Twisting by | 0.1 | — | 0.03 | — | 1 | 5 | 12 | — |
| hollow cylinder | | | | | | | | |
| rotation [U/m] | | | | | | | | |
| Twisting by tube | — | 0.1 | — | 0.03 | — | — | — | — |
| strand rotation | | | | | | | | |
| [U/m] | | | | | | | | |
| Ovality | 0.01 | 0.01 | 0.025 | 0.025 | 0.025 | 0.025 | 0.03 | 0.05 |
| [mm] | | | | | | | | |
| Bend | 0.2 | 0.2 | 0.2 | 0.2 | 0.9 | 2.1 | >3 | 0.20 |
| [mm/m] | | | | | | | | |

1. A method for producing a tube of quartz glass, said method comprising:
elongating a hollow cylinder of quartz glass that is continuously supplied to a heating zone;
softening said hollow cylinder so as to form a softened region thereof in the heating zone;
drawing a tube strand in the direction of a drawing axis out of the softened region by using a roll puller, the said roll puller having gin a frame by on which a plurality of puller rolls are supported so as to each be fixed, rotatable around a respective rotation axis, and said puller rolls being distributed around the circumference of the tube strand and each engaging the tube strand with their a respective cylindrical outer surface thereof, the frame of the roll puller being stationary; and
providing relative rotation of the hollow cylinder relative to the tube strand about the drawing axis, the relative rotation being in a range between 0.01 and 5 revolutions per linear meter of the tube strand as said tube strand drawn is off from the hollow cylinder.

2. The method according to claim 1, wherein the relative rotation is in a range of less than 1 revolution per linear meter of the tube strand as drawn off.

3. The method according to claim 1, wherein the relative rotation is in a range between 0.05 and 0.5 revolutions per linear meter of the tube strand as drawn off.

4. The method according to claim 1, wherein the hollow cylinder rotates about the drawing axis, and the puller rolls are pressed with a pressing force against the tube strand, said pressing force preventing a rotation of the tube strand with the hollow cylinder.

5. The method according to claim 1, wherein the tube strand rotates about the drawing axis.

6. The method according to claim 5, wherein the puller rolls each rotate about the respective rotation axis of the puller rolls, and the rotation of the tube strand takes place with at least one of the puller rolls oriented relative to the drawing axis in such an oblique orientation that the rotational axis of the puller rolls forms a tilt angle with the drawing axis that is not 90 degrees.

7. The method according to claim 6, wherein the tilt angle differs by not more than 10 degrees from 90 degrees.

8. The method according to claim 6, wherein all of the puller rolls are obliquely oriented relative to the drawing axis.

9. The method according to claim 1, wherein during the drawing process, a measure is determined for the ovality or siding of the tube strand, and the determined measure is used for controlling the rate of the relative rotation.

10. The method according to claim 1, wherein the hollow cylinder is of quartz glass, said hollow cylinder having radial final dimensions produced by machining.

11. The method according to claim 1, wherein the tube strand is drawn off with a wall thickness in the range of from 0.1 to 3 mm.

12. The method according to claim 2, wherein the hollow cylinder rotates about the drawing axis, and the puller rolls are pressed with a pressing force against the tube strand, said pressing force preventing a rotation of the tube strand with the hollow cylinder.

13. The method according to claim 3, wherein the hollow cylinder rotates about the drawing axis, and the puller rolls are pressed with a pressing force against the tube strand, said pressing force preventing a rotation of the tube strand with the hollow cylinder.

14. The method according to claim 2, wherein the tube strand rotates about the drawing axis.

15. The method according to claim 3, wherein the tube strand rotates about the drawing axis.

16. The method according to claim 7, wherein all of the puller rolls are obliquely oriented relative to the drawing axis.

17. The method according to claim 2, wherein during the drawing process a measure is determined for the ovality or siding of the tube strand, and the determined measure is used for controlling the rate of the relative rotation.

18. The method according to claim 3, wherein during the drawing process a measure is determined for the ovality or siding of the tube strand, and the determined measure is used for controlling the rate of the relative rotation.

19. The method according to claim 4, wherein during the drawing process a measure is determined for the ovality or siding of the tube strand, and the determined measure is used for controlling the rate of the relative rotation.

20. The method according to claim 8, wherein during the drawing process a measure is determined for the ovality or siding of the tube strand, and the determined measure is used for controlling the rate of the relative rotation.
